(19) United States
(12) Patent Application Publication
(10) Pub. No.: US 2026/0170396 A1
(43) Pub. Date: Jun. 18, 2026

(54) STORING A MACHINE LEARNING MODEL USING DIFFERENTIAL STORAGE OF TENSOR DATA

(71) Applicant: Dell Products L.P., Round Rock, TX (US)

(72) Inventors: Qi Bao, Acton, MA (US); Emine Ugur Kaynar Terzioglu, Boston, MA (US); Gaurav Chawla, Austin, TX (US)

(21) Appl. No.: 18/979,195

(22) Filed: Dec. 12, 2024

(51) Int. Cl. G06N 20/00

(52) U.S. Cl. CPC G06N 20/00

(57) ABSTRACT

The technologies described herein are generally directed toward storing machine learning model data using differential storage of tensor data. For instance, a system can enable performance of operations including storing, as data chunks in storage, a first tensor version including first model parameters of a machine learning model and, after the first tensor version was stored, the first model parameters have been changed to second model parameters of the machine learning model, resulting in a second tensor version that includes the second model parameters. The method may further include, based on a command to checkpoint the machine learning model, determining a changed data chunk of the data chunks corresponding to a change from the first tensor version to the second tensor version. Further, the method may include storing the changed data chunk as a checkpoint of the machine learning model.

### BACKGROUND

Modern systems that implement artificial intelligence (AI)/machine learning (ML) systems may manage multiple storage intensive operations. Tensors are multidimensional arrays that may be used to train AI/ML models and, as workloads evolve, both new and older versions of a tensor may need to be persisted for future use.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include storing, as data chunks in storage, a first tensor version including first model parameters of a machine learning model and, after the first tensor version was stored, the first model parameters have been changed to second model parameters of the machine learning model, resulting in a second tensor version that includes the second model parameters. The method may further include, based on a command to checkpoint the machine learning model, determining a changed data chunk of the data chunks corresponding to a change from the first tensor version to the second tensor version. Further, the method may include storing the changed data chunk as a checkpoint of the machine learning model.

In additional or alternative embodiments, the method may further include, based further on the command, storing, by the system to the storage, the machine learning model according to a defined format that stores the machine learning model and the second model parameters separately. In additional or alternative embodiments, the defined format further stores the machine learning model according to a framework agnostic data format.

In additional or alternative embodiments, the method may further include, receiving a second command to deploy the machine learning model to deployment equipment, and the deployment equipment currently operates the machine learning model using the first model parameters. In additional or alternative embodiments, the method may further include, identifying the changed data chunk as corresponding to the change from the first tensor version to the second tensor version.

In additional or alternative embodiments, the method may further include, based on the identifying of the changed data chunk, facilitating deployment of the changed data chunk to the deployment equipment. In additional or alternative embodiments, the checkpoint includes a first checkpoint and the method may further include, determining that a further changed data chunk of the data chunks corresponds to a further change of the changed data chunk from the second tensor version to a third tensor version. In additional or alternative embodiments, the method may further include, storing by the system to the storage, the further changed data chunk as a second checkpoint of the machine learning model.

In additional or alternative embodiments, the method may further include, based on a restore checkpoint command to restore the first checkpoint, retrieving the changed data chunk from the storage, and based on the first tensor version and the second tensor version, generating a restored machine learning model without the further change from the second tensor version to the third tensor version. In additional or alternative embodiments, the system includes a model training system that utilizes tensors to train the machine learning model. In additional or alternative embodiments, the first model parameters were generated based on the training of the machine learning model. In additional or alternative embodiments, the second model parameters resulted from a further training of the machine learning model.

In additional or alternative embodiments, the method may further include, based on the first tensor version and the second tensor version, generating version tracking data for the second tensor version. In additional or alternative embodiments, the method may further include, based on the version tracking data, identifying elements of the change from the first tensor version to the second tensor version.

An example system can operate as follows. At least one memory may store computer executable instructions, and at least one processor may be configured to process the computer executable instructions that, when executed by the at least one processor, facilitate performance of operations. The operations may include storing data chunks that include an initial version of model training weights for a machine learning model. The operations may further include, based on a checkpoint operation applied to the machine learning model, receiving, from a model training engine, a changed data chunk of the data chunks, resulting in checkpoint data for the model training weights being stored, wherein the changed data chunk corresponds to changed model training weights that resulted from a change made to the initial version of the model training weights.

In additional or alternative embodiments, the operations may further include, receiving, from a requesting device, a request to restore the changed model training weights, based on the request, identifying the changed data chunk as containing the changed model training weights, and based on the data chunks of the initial version of the model training weights and the changed data chunk, communicating a restored version of the changed model training weights to the requesting device, in response to the request. In additional or alternative embodiments, the operations may further include, receiving data corresponding to the machine learning model in an interoperable format, and storing the data according to a data chunk format. In additional or alternative embodiments, initial version of the model weights are comprised in a tensor data model, and the operations further comprise, receiving, via an application programming interface, the tensor data model.

An example non-transitory machine-readable medium may include executable instructions that, when executed by at least one processor, facilitate performance of operations. The operations may include storing, as data blocks in a backup storage system, a model weight array of a predictive model, resulting in an initial stored array. The operations may further include, based on a comparison of the initial stored array with a later state of the model weight array, identifying a data block of data blocks used to store the later state of the model weight array that were changed since the stored array was stored, resulting in changed data blocks. The operations may include storing the changed data blocks in the backup storage system. The operations may further include communicating, to the backup storage system, a request to restore the changed data blocks, and receiving, from the backup storage system, restored data blocks corresponding to the changed data blocks. In operations, the restored data blocks are combined with initial data blocks, resulting in a restored model weight array of the predictive model.

In additional or alternative embodiments, the changed data blocks are stored as a snapshot of the later state of the model weight array. In additional or alternative embodiments, the machine learning device includes a host device and a compute device, and the storing of the changed data blocks in the backup storage system results from receiving a checkpoint request. In additional or alternative embodiments, the operations may further include, based on the checkpoint request, copying the later state of the model weight array from a compute memory of the compute device to a host memory of the host device, and the comparison of the initial stored array with the later state of the model weight array is performed by the host device. In additional or alternative embodiments, the operations may further include, receiving a restore request for restoring the snapshot, retrieving the changed data blocks, and combining the changed data blocks of the snapshot with the data blocks of the initial stored array, resulting in a restored model weight array.

In additional or alternative embodiments, the retrieving of the changed data blocks includes retrieving the changed data blocks into the host memory, with the combining of the snapshot with the initial stored array including, combining, by the host device, the snapshot with the initial stored array. In additional or alternative embodiments, the operations may further include copying the restored model weight array from the host memory to the compute memory. In additional or alternative embodiments, the operations may further include, storing, to the backup storage system, layer architecture data representative of a layer architecture of the predictive model, and hyperparameters of the predictive model.

In additional or alternative embodiments, the later state of the model weight array is combined with data corresponding to a layer architecture of the predictive model, in an integrated model formatted in accordance with a framework specific data format. In additional or alternative embodiments, the operations further comprise, receiving, by the host device, the integrated model, and converting, by the host device, the integrated model into the model weight array, and the data corresponding to the layer architecture. In additional or alternative embodiments, the integrated model further comprises hyperparameters of the predictive model, and the converting of the integrated model includes converting the integrated model further with the hyperparameters.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system 100 that can facilitate storing machine learning model data using differential storage of tensor data, in accordance with one or more embodiments.

FIG. 2 is an architecture diagram of an example system 200 that can facilitate storing machine learning model data using differential storage of tensor data, in accordance with one or more embodiments.

FIG. 3 is an architecture diagram of an example system 300 that can facilitate storing machine learning model data using differential storage of tensor data, in accordance with one or more embodiments.

FIG. 4 is a diagram of an example system 400 that can facilitate storing machine learning model data using differential storage of tensor data, in accordance with one or more embodiments.

FIG. 5 is a diagram of example system 500 that can facilitate storing machine learning model data using differential storage of tensor data, in accordance with one or more embodiments.

FIG. 6 depicts a flow diagram representing example operations of an example method 600 that can facilitate storing machine learning model data using differential storage of tensor data, in accordance with one or more embodiments.

FIG. 7 depicts an example system that can facilitate storing machine learning model data using differential storage of tensor data, in accordance with one or more embodiments.

FIG. 8 depicts an example non-transitory machine-readable medium that can include executable instructions that, when executed by a processor of a system, can facilitate storing machine learning model data using differential storage of tensor data, in accordance with one or more embodiments.

FIG. 9 depicts an example schematic block diagram of a computing environment with which the disclosed subject matter can interact.

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance of a computing system that implements and/or otherwise interacts with an LLM or other similar machine learning model can be improved, e.g., by reducing latency and performance losses that can occur when checkpointing or restoring increasingly large machine learning models. In addition, one or more embodiments may reduce the inefficiencies involved in the proprietary storage of multiple parts of a machine language model in a single file. Further, it is noted that implementations described herein can provide solutions to technical problems that are inextricably tied to computer systems, and provide these solutions in a manner that cannot reliably be performed by a human or even a plurality of humans, e.g., analyzing multiple versions of a complex large language model to identify changes that may only appear in machine coding, and continually managing the storage of difference checkpoints across development and deployment servers. For instance, due to the speed at which a computer processes data, the amount of data that can be processed by a computer in parallel, the rate at which resource usage of a computer can fluctuate during execution of a process, and/or other factors, it is not possible for a human to measurably improve storage and retrieval operations by analyzing the contents of files that in some implementations have massive amounts of encoded data.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

As mentioned in the background, as workloads evolve, both new and older versions of a tensor may need to be persisted for future use. In response to the need for ongoing storage of changed tensors over time, model developers may simply allocate more storage and computational resources to continually store multiple copies of tensors, as they are changed. Problems resulting from inefficient storage of training data may be aggravated as the use of raw data that includes complex multimedia continues to increase.

As used herein, “tensor” describes a multidimensional array that includes model parameters generated based on processing source/raw data. To enable models to learn intricate patterns in raw data samples, a training dataset may be used multiple times to train the AI model, e.g., in multiple training epochs. One or more embodiments provide a tensor storage that can take tensor snapshots and track differences between snapshots so that only differences in a tensor are stored.

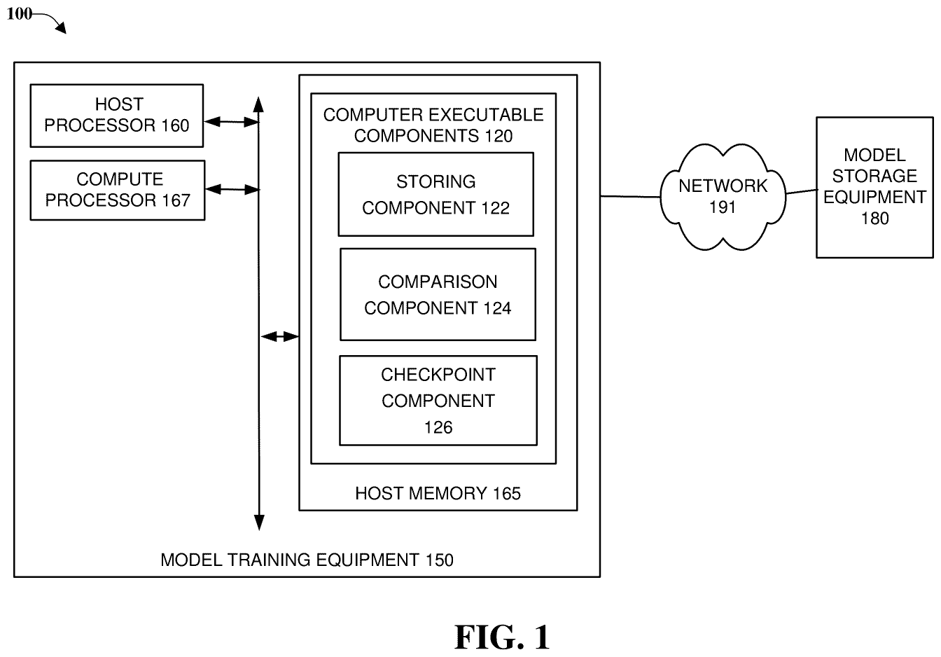

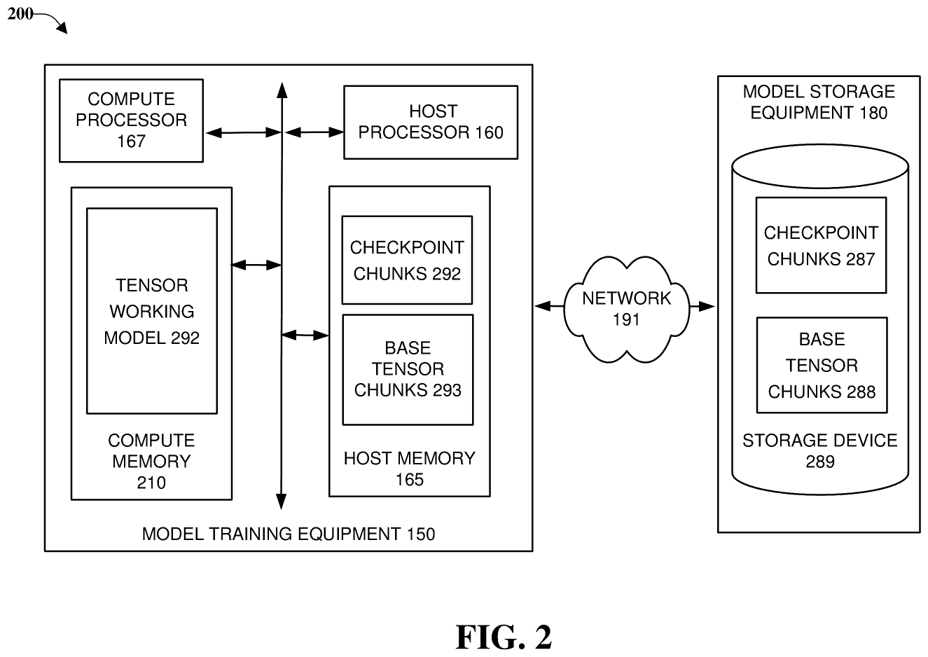

FIGS. 1 and 2 describe different aspects of one or more embodiments of model training equipment and model storage equipment. FIG. 1 is an architecture diagram of an example system 100 that can facilitate storing machine learning model data using differential storage of tensor data, in accordance with one or more embodiments. FIG. 2 is an architecture diagram of an example system 200 that can facilitate storing machine learning model data using differential storage of tensor data, in accordance with one or more embodiments. Depicted, systems 100 and 200 include model training equipment 150 connected, via network 191, to model storage equipment 180. Model training equipment 150 includes host processor 160, compute processor 167, host memory 165, and compute memory 210. Model storage equipment 180 includes storage device 289. For purposes of brevity, description of like elements and/or processes employed in other embodiments is omitted.

In an example, host memory 165 and compute memory 210 may provide nonvolatile storage of data, data structures, computer executable instructions, and so forth. Compute memory 210 is depicted as storing tensor working model 292, and host memory 165 stores checkpoint chunks 292 and base tensor chunks 293. In some implementations, compute memory 210 is memory designed to provide memory for compute processor 167 to perform model training operations, and host memory 165 provides memory for operation of hosting functions for compute processor 167. Descriptions of processes are included below whereby compute memory 210 and host memory 165 exchange information during operation of embodiments.

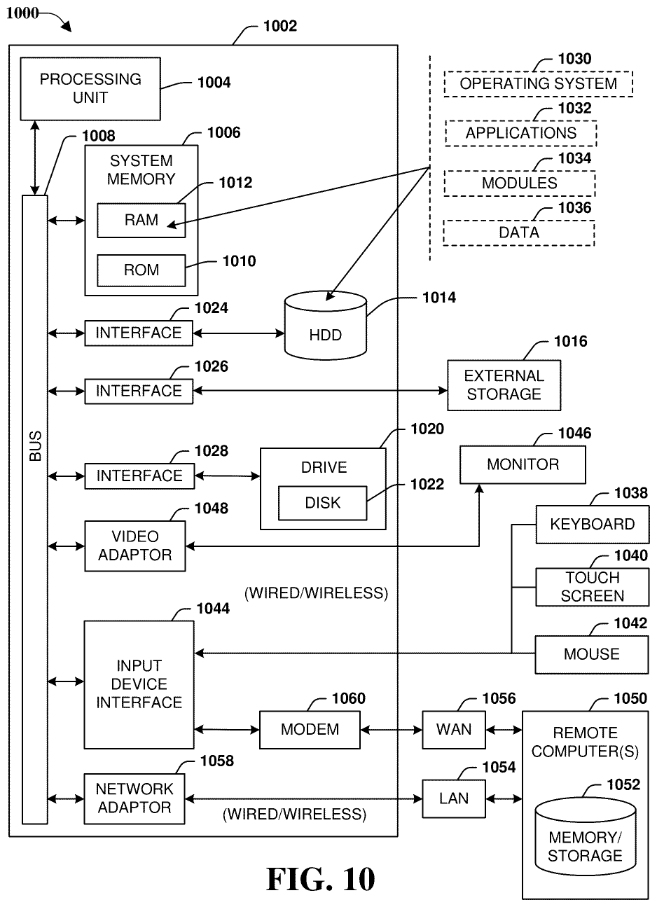

According to multiple embodiments, host processor 160 can comprise one or more processors and/or electronic circuitry that can implement one or more computer and/or machine readable, writable, and/or executable components and/or instructions that can be stored on host memory 165. For example, host processor 160 can perform various operations that can be specified by such computer and/or machine readable, writable, and/or executable components and/or instructions including, but not limited to, logic, control, input/output (I/O), arithmetic, and/or the like. In some embodiments, host processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processors that may be used for host processor 160 are described below with reference to processing unit 1004 of FIG. 10. Such examples of processor 160 can be employed to implement any embodiments of the subject disclosure.

Host memory 165 further stores one or more computer and/or machine readable, writable, and/or executable components 120 and/or instructions. In one or more embodiments, computer executable components 120, when executed by host processor 160, can facilitate performance of operations defined by the executable component(s) and/or instruction(s). Computer executable components 120 can include storing component 122, comparison component 124, checkpoint component 126, and other components described or suggested by different embodiments described herein, that can improve the operation of systems 100 and 200.

As discussed further with FIG. 10 below, network 191 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In some embodiments, host memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of host memory 165 are described below with reference to system memory 1006 and FIG. 10. Such examples of host memory 165 can be employed to implement any embodiments of the subject disclosure.

In one or more embodiments, computer executable components 120 can be used in connection with implementing one or more of the systems, devices, components, and/or computer-implemented operations shown and described in connection with FIGS. 1 and 2, and other figures disclosed herein. In an example, host memory 165 can store executable instructions that can facilitate generation of storing component 122, which can in some implementations store, as data chunks in storage, a first tensor version, with the first tensor version including first model parameters of a machine learning model, and, after the first tensor version was stored, the first model parameters have been changed to second model parameters of the machine learning model, resulting in a second tensor version that includes the second model parameters. For example, in one or more embodiments storing component 122 may store, as data chunks in host memory 165, a first version of tensor working model 292, with the first tensor version being stored as base tensor chunks 293, and including first model parameters of a machine learning model. As compute processor 167 continues to manipulate tensor working model 292 in compute memory 210, tensor working model 292 changes into a second version, with some of the first model parameters stored with base tensor chunks 293 being changed to second model parameters in tensor working model 292.

In another example, host memory 165 can store executable instructions that can facilitate generation of comparison component 124, which can in some implementations, based on a command to checkpoint the machine learning model, determine a changed data chunk of the data chunks corresponding to a change from the first tensor version to the second tensor version. In one or more embodiments, comparison component 124 may, based on a command to checkpoint the machine learning model of compute memory 210, determine one or more changed data chunks of tensor working model 292, e.g., by comparing the base tensor chunks 293 to the current state of tensor working model 292 data chunks that have been changed may be identified. The chunk identified by comparison component 124 may correspond to the entire tensor or the tensor may be divided across multiple chunks, with the identified chunks corresponding to a changed portion of the tensor, and with other chunks of the tensor remaining unchanged.

In another example, host memory 165 can store executable instructions that can facilitate generation of checkpoint component 126, which can in some implementations may store the changed data chunk as a checkpoint of the machine learning model. For example, in one or more embodiments, checkpoint component 126 may store the one or more identified changed data chunks as checkpoint chunks in host memory 165.

In this example, checkpoint chunks 292 may also be termed a snapshot of tensor data, e.g., a differential snapshot that includes modifications to base tensor chunks 293. With differential snapshots, each snapshot may include the new or modified data since the last full snapshot (e.g., base tensor chunks 293), rather than duplicating the entire dataset. One or more embodiments may thus reduce the use of storage space in host memory 189, make tracking changes more efficient, and reduce the time it takes to store changes to the tensor over time.

It is appreciated that the embodiments of the subject disclosure depicted in various figures disclosed herein are for illustration only, and as such, the architecture of such embodiments are not limited to the systems, devices, and/or components depicted therein. For example, in some embodiments, model training equipment 150, model storage equipment 180, and other devices discussed herein, can further comprise various computer and/or computing-based elements described herein with reference to operating environment 1000 and FIG. 10. In one or more embodiments, such computer and/or computing-based elements can be used in connection with implementing one or more of the systems, devices, components, and/or computer-implemented operations shown and described in connection with FIGS. 1, 2, or other figures disclosed herein.

It should be noted that model training equipment 150, model storage equipment 180, and other devices discussed herein, can execute code instructions that may operate on servers or systems, remote data centers, or ‘on-box’ in individual client information handling systems, according to various embodiments described herein. In some embodiments, it is understood any or all implementations of one or more embodiments described herein can operate on a plurality of computers, collectively referred to as model training equipment 150. For example, one or more of model training equipment 150, and model storage equipment 180 can all be separate subsystems running in the kernel of a computing device as well as operating on separate network equipment, e.g., as depicted in FIGS. 1 and 2.

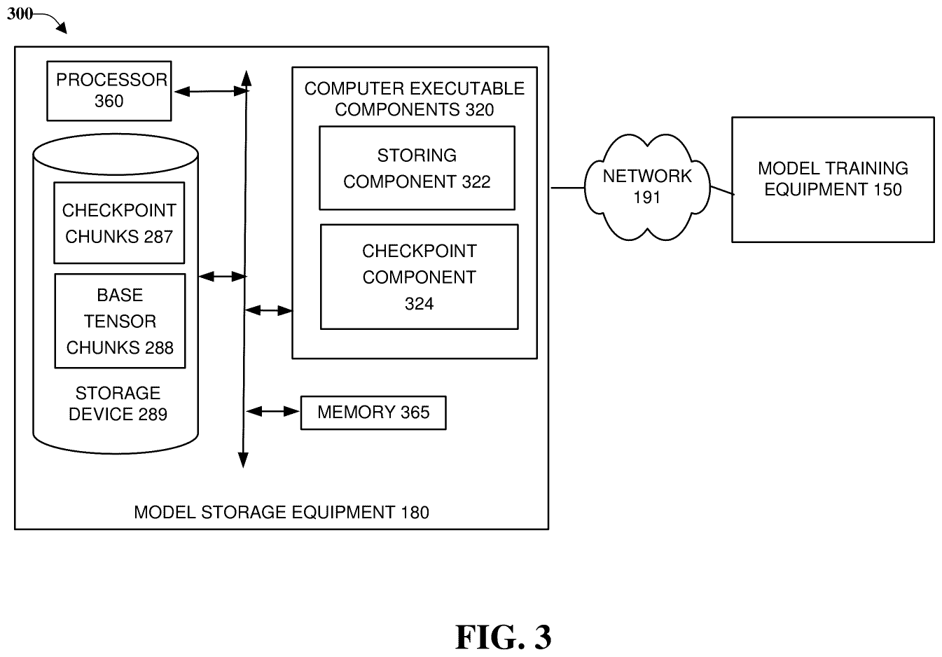

FIG. 3 is an architecture diagram of an example system 300 that can facilitate storing machine learning model data using differential storage of tensor data, in accordance with one or more embodiments. As depicted, system 300 includes model storage equipment 180 connected, via network 191, to model training equipment 150. Model storage equipment 180 includes processor 360, memory 365, storage device 289, and computer executable components 320. Storage device 289 stores checkpoint chunks 287 and base tensor chunks 288. For purposes of brevity, description of like elements and/or processes employed in other embodiments is omitted.

In embodiments, processor 360 is similar to host processor 160. According to multiple embodiments, memory 365 can store one or more computer and/or machine readable, writable, and/or executable components 320 and/or instructions. In one or more embodiments, computer executable components 320, when executed by processor 360, can facilitate performance of operations defined by the executable component(s) and/or instruction(s). Computer executable components 320 can include storing component 322, checkpoint component 324, and other components described or suggested by different embodiments described herein, e.g., that can improve the operation of system 300, in accordance with one or more embodiments.

In an example implementation of model storage equipment 180, memory 365 can store executable instructions that can facilitate generation of storing component 322, which in some implementations, may store data chunks that include an initial version of model training weights for a machine learning model. For example, in an embodiment, storing component 322 may base tensor chunks 288 of the machine learning model.

In an example implementation of model storage equipment 180, memory 365 can further store executable instructions that can facilitate generation of checkpoint component 324, which in some implementations, may, based on a checkpoint operation applied to the machine learning model, receive, from a model training engine, a changed data chunk of the data chunks, resulting in checkpoint data for the model training weights being stored, wherein the changed data chunk corresponds to changed model training weights that resulted from a change made to the initial version of the model training weights. In an example, checkpoint component 324 may, based on a checkpoint operation applied to the machine learning model, receive, from model training equipment 150, a changed data chunk, resulting in checkpoint chunks 287 being stored in storage device 289, with the changed data chunk corresponds to changed model training weights that resulted from the changes made to base tensor chunks 288.

In additional or alternative embodiments, compute processor 167 copies the later state of the model weight array in a framework specific data format, combined with data corresponding to a layer architecture of the predictive model, in an integrated model formatted in accordance with a framework specific data format. In additional or alternative embodiments, the host device receives the integrated model, and converts the integrated model into the model weight array, and the data corresponding to the layer architecture. In additional or alternative embodiments, the integrated model further includes a hyperparameter of the predictive model, and the converting of the integrated model, includes converting the integrated model further with the hyperparameter.

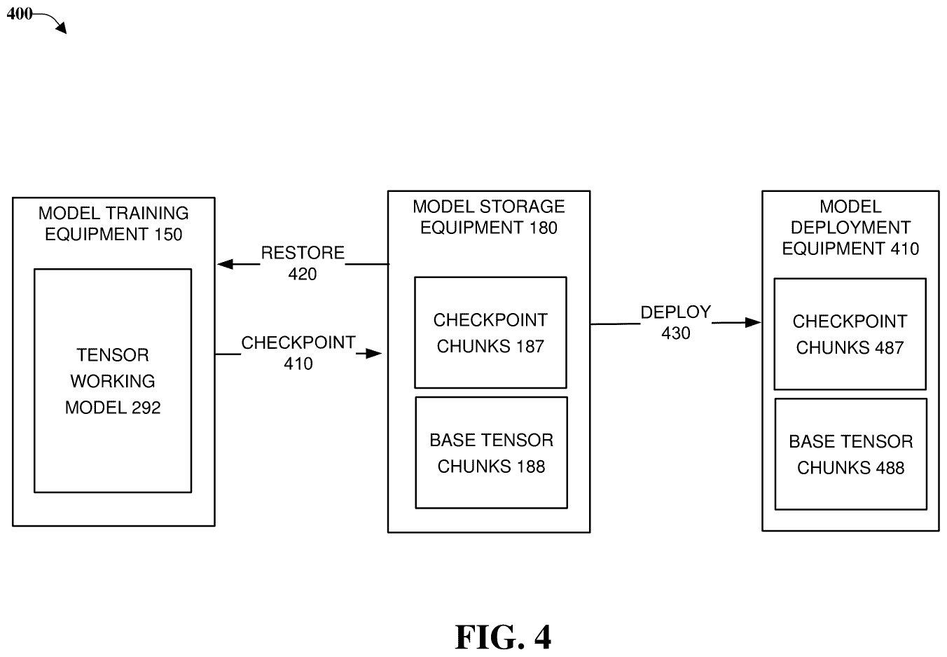

FIG. 4 is a diagram of an example system 400 that can facilitate storing machine learning model data using differential storage of tensor data, in accordance with one or more embodiments. As depicted, system 400 includes model storage equipment 180 connected to model training equipment 150 and model deployment equipment 410. Model training equipment 150 stores tensor working model 292, model storage equipment stores checkpoint chunks 187 and base tensor chunks 188, and model deployment equipment 410 includes checkpoint chunks 487 and base tensor chunks 488. For purposes of brevity, description of like elements and/or processes employed in other embodiments is omitted.

In one or more embodiments, model training equipment can initially copy to model storage equipment base tensor chunks 188, and later perform checkpoint 410 by copying checkpoint chunks 187. In one or mor embodiments, model storage equipment 180 may act as a persistent data storage for machine learning models turning a development/maintenance phase.

In an implantation, model storage equipment 180, after receiving base tensor chunks 188, may deploy base tensor chunks 188 to model deployment equipment 410, e.g., stored as base tensor chunks 488. Continuing this example, after receiving checkpoint chunks 187 from model training equipment 150, one or more embodiments may deploy 430 checkpoint chunks 187 to model deployment equipment 410, e.g., stored as checkpoint chunks 487. Deploying checkpoint chunks 187 to model deployment equipment 410 may act as a differential deployment operation, thus reducing the amount of data copied during the deployment, e.g., only the changes made to the model since the last deployment.

In another operation depicted in FIG. 4, upon receiving a request to restore 420 to a previous version (e.g., corresponding to checkpoint chunks 187) of the machine learning model, model storage equipment 180 may combine checkpoint chunks 187 with one or more of base tensor chunks 488. In an implementation, this approach may be used to restore 420 the previously checkpointed version of tensor working model 292 for modification by model training equipment 150.

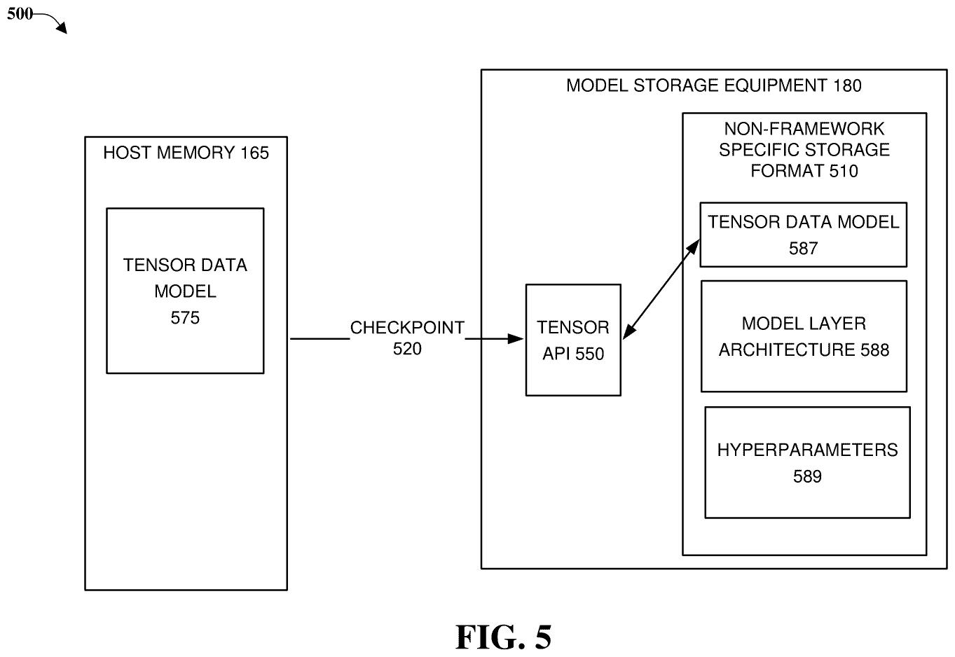

FIG. 5 is a diagram of an example system 500 that can facilitate storing machine learning model data using differential storage of tensor data, in accordance with one or more embodiments. For purposes of brevity, description of like elements and/or processes employed in other embodiments is omitted.

As depicted, system 500 includes host memory 165 of model storage equipment 180 connected to model training equipment 150. Model storage equipment includes tensor application programming interface (API) 550, and the machine learning model stored in non-framework specific storage format 510, which includes tensor data model 587, model layer architecture 588, and hyperparameters 589, host memory 165 includes tensor data model 575.

In one or more embodiments, host processor 160 received tensor working model 292 from compute processor 167 in a framework specific data format, that combined model weights with the layer architecture of the machine learning model, e.g., a model where both model weights and model architecture were integrated together. In an implementation, host processor 160 converted the integrated model into a model where machine learning model elements (e.g., weights, model, and hyperparameters) could be stored separately, e.g., tensor data model 587, model layer architecture 588, and hyperparameters 589.

When tensor data model 575 is checkpointed 520 to model storage equipment 180, tensor API can receive and store tensor data model 575 using the differential checkpoint approaches described elsewhere herein.

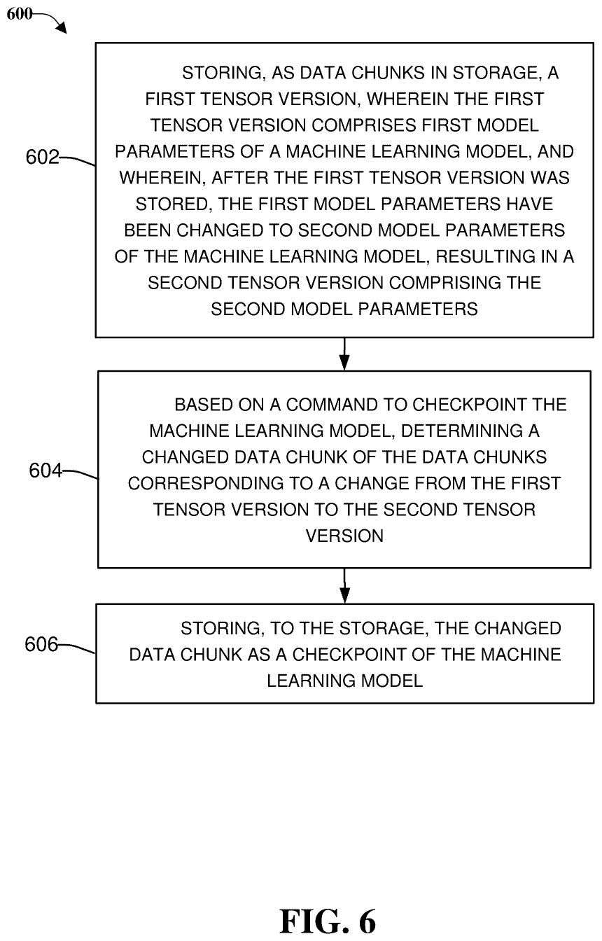

FIG. 6 depicts a flow diagram representing example operations of an example method 600 that can facilitate storing machine learning model data using differential storage of tensor data, in accordance with one or more embodiments. For purposes of brevity, description of like elements and/or processes employed in other embodiments is omitted.

Example elements of methods that may be utilized in accordance with certain embodiments of this disclosure are described below. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In some examples, one or more embodiments of method 600 can be implemented by storing component 122, comparison component 124, checkpoint component 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, storing component 122 of model training equipment 150 can, in one or more embodiments, storing, as data chunks in storage, a first tensor version including first model parameters of a machine learning model and, after the first tensor version was stored, the first model parameters have been changed to second model parameters of the machine learning model, resulting in a second tensor version that includes the second model parameters. At 604 of method 600, comparison component 124 can, in one or more embodiments, based on a command to checkpoint the machine learning model, determining a changed data chunk of the data chunks corresponding to a change from the first tensor version to the second tensor version. At 606 of method 600, checkpoint component 126 can, in one or more embodiments, storing the changed data chunk as a checkpoint of the machine learning model.

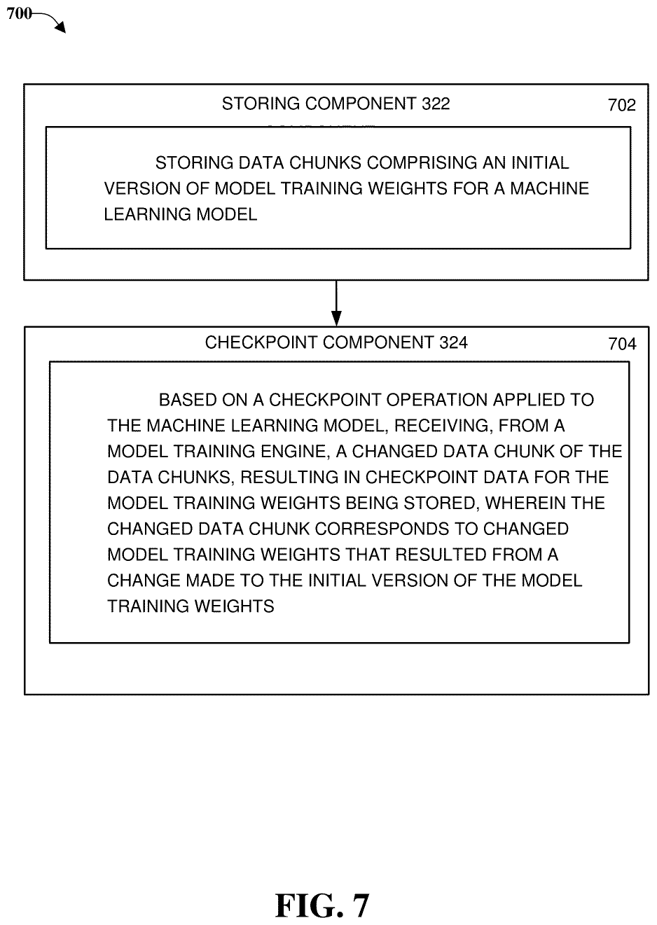

FIG. 7 depicts an example system 700 that can facilitate storing machine learning model data using differential storage of tensor data, in accordance with one or more embodiments. For purposes of brevity, description of like elements and/or processes employed in other embodiments is omitted.

Example system 700 can include storing component 322, checkpoint component 324, and other components that can be used to implement aspects of system 700, as described herein, in accordance with one or more embodiments. At 702 of FIG. 7, storing component 322 can store data chunks that include an initial version of model training weights for a machine learning model. At 704 of FIG. 7, checkpoint component 324 can, based on a checkpoint operation applied to the machine learning model, receive, from a model training engine, a changed data chunk of the data chunks, resulting in checkpoint data for the model training weights being stored, with the changed data chunk corresponding to changed model training weights that resulted from a change made to the initial version of the model training weights.

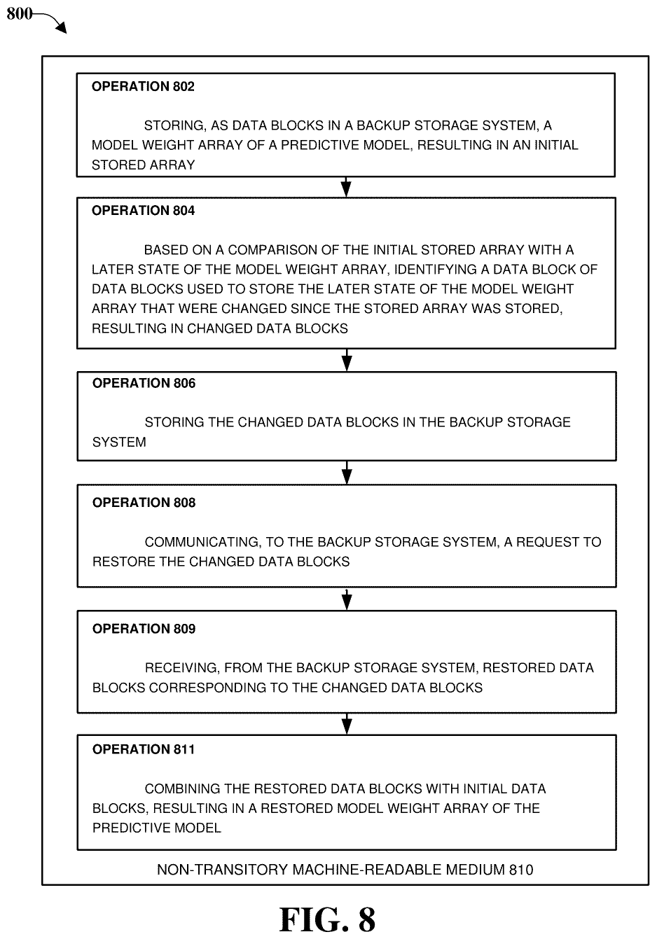

FIG. 8 depicts an example 800 non-transitory machine-readable medium 810 that can include executable instructions that, when executed by a processor of a system, can facilitate storing machine learning model data using differential storage of tensor data, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which includes storing, as data blocks in a backup storage system, a model weight array of a predictive model, resulting in an initial stored array. The operations may further include operation 804 which, in one or more embodiments includes, based on a comparison of the initial stored array with a later state of the model weight array, identifying a data block of data blocks used to store the later state of the model weight array that were changed since the stored array was stored, resulting in identified data blocks. The operations may include storing the identified data blocks in the backup storage system.

The operations may further include operation 806 which, in one or more embodiments includes, storing the changed data blocks in the backup storage system. The operations may further include operation 808 which, in one or more embodiments includes, communicating, to the backup storage system, a request to restore the changed data blocks.

The operations may further include operation 809 which, in one or more embodiments includes, receiving, from the backup storage system, restored data blocks corresponding to the changed data blocks. The operations may further include operation 811 which, in one or more embodiments includes, combining the restored data blocks with initial data blocks, resulting in a restored model weight array of the predictive model.

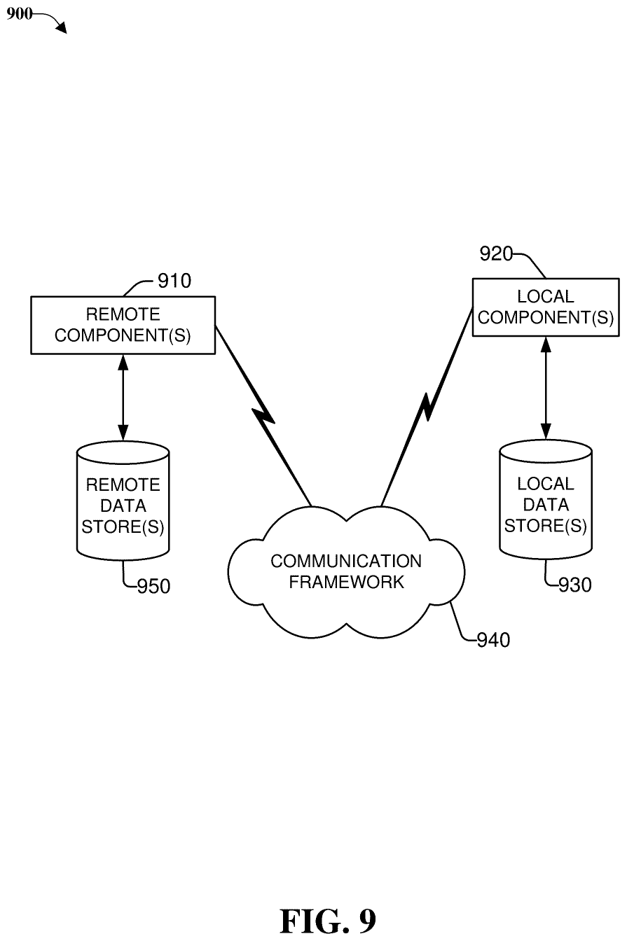

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 2020 (see below), non-volatile memory 2022 (see below), disk storage 2024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
storing, by a system comprising at least one processor, as data chunks in storage, a first tensor version, wherein the first tensor version comprises first model parameters of a machine learning model, and wherein, after the first tensor version was stored, the first model parameters have been changed to second model parameters of the machine learning model, resulting in a second tensor version comprising the second model parameters;
based on a command to checkpoint the machine learning model, determining, by the system, a changed data chunk of the data chunks corresponding to a change from the first tensor version to the second tensor version; and
storing, by the system to the storage, the changed data chunk as a checkpoint of the machine learning model.

2. The method of claim 1, further comprising:
based further on the command, storing, by the system to the storage, the machine learning model according to a defined format that stores the machine learning model and the second model parameters separately.

3. The method of claim 2, wherein the defined format further stores the machine learning model according to a framework agnostic data format.

4. The method of claim 1, wherein the command comprises a first command, and wherein the method further comprises:
receiving, by the system, a second command to deploy the machine learning model to deployment equipment, wherein the deployment equipment currently operates the machine learning model using the first model parameters;
identifying the changed data chunk as corresponding to the change from the first tensor version to the second tensor version; and
based on the identifying of the changed data chunk, facilitating, by the system, deployment of the changed data chunk to the deployment equipment.

5. The method of claim 1, wherein the checkpoint comprises a first checkpoint, and wherein the method further comprises:
determining, by the system, that a further changed data chunk of the data chunks corresponds to a further change of the changed data chunk from the second tensor version to a third tensor version; and
storing, by the system, by the system to the storage, the further changed data chunk as a second checkpoint of the machine learning model.

6. The method of claim 5, further comprising, based on a restore checkpoint command to restore the first checkpoint:
retrieving, by the system, the changed data chunk from the storage; and
based on the first tensor version and the second tensor version, generating, by the system, a restored machine learning model without the further change from the second tensor version to the third tensor version.

7. The method of claim 1, wherein the system comprises a model training system that utilizes tensors to train the machine learning model.

8. The method of claim 1, wherein the first model parameters were generated based on the training of the machine learning model.

9. The method of claim 8, wherein the second model parameters resulted from a further training of the machine learning model.

10. The method of claim 1, further comprising, based on the first tensor version and the second tensor version, generating, by the system, version tracking data for the second tensor version.

11. The method of claim 10, further comprising, based on the version tracking data, identifying, by the system, elements of the change from the first tensor version to the second tensor version.

12. A computing system, comprising:
at least one memory that stores computer executable instructions; and
at least one processor configured to process the computer executable instructions that, when executed by the at least one processor, facilitate performance of operations, comprising:
storing data chunks comprising an initial version of model training weights for a machine learning model, and
based on a checkpoint operation applied to the machine learning model, receiving, from a model training engine, a changed data chunk of the data chunks, resulting in checkpoint data for the model training weights being stored, wherein the changed data chunk corresponds to changed model training weights that resulted from a change made to the initial version of the model training weights.

13. The computing system of claim 12, wherein the operations further comprise:
receiving, from a requesting device, a request to restore the changed model training weights;
based on the request, identifying the changed data chunk as containing the changed model training weights; and
based on the data chunks of the initial version of the model training weights and the changed data chunk, communicating a restored version of the changed model training weights to the requesting device, in response to the request.

14. The computing system of claim 12, wherein the operations further comprise:
receiving data corresponding to the machine learning model in an interoperable format; and
storing the data according to a data chunk format.

15. The computing system of claim 12, wherein the initial version of the model training weights are comprised in a tensor data model, and wherein the operations further comprise, receiving, via an application programming interface, the tensor data model.

16. A non-transitory machine-readable medium comprising executable instructions that, when executed by at least one processor of a machine learning device, facilitate performance of operations, the operations comprising:
storing, as data blocks in a backup storage system, a model weight array of a predictive model, resulting in an initial stored array comprising initial data blocks;
based on a comparison of the initial stored array with a later state of the model weight array, identifying a data block of data blocks used to store the later state of the model weight array that were changed since the initial stored array was stored, resulting in changed data blocks;
storing the changed data blocks in the backup storage system;
communicating, to the backup storage system, a request to restore the changed data blocks;
receiving, from the backup storage system, restored data blocks corresponding to the changed data blocks;
combining the restored data blocks with initial data blocks, resulting in a restored model weight array of the predictive model.

17. The non-transitory machine-readable medium of claim 16, wherein the changed data blocks are stored as a snapshot of the later state of the model weight array.

18. The non-transitory machine-readable medium of claim 16, wherein the machine learning device comprises a host device and a compute device, wherein the storing of the changed data blocks in the backup storage system results from receiving a checkpoint request, wherein the operations further comprise, based on the checkpoint request, copying the later state of the model weight array from a compute memory of the compute device to a host memory of the host device, and wherein the comparison of the initial stored array with the later state of the model weight array is performed by the host device.

19. The non-transitory machine-readable medium of claim 18, wherein the later state of the model weight array is comprised, with data corresponding to a layer architecture of the predictive model, in an integrated model formatted in accordance with a framework specific data format, and wherein the operations further comprise:
receiving, by the host device, the integrated model; and
converting, by the host device, the integrated model into the model weight array, and the data corresponding to the layer architecture.

20. The non-transitory machine-readable medium of claim 19, wherein the integrated model further comprises a hyperparameter of the predictive model, and wherein the converting of the integrated model comprises converting the integrated model further with the hyperparameter.
